(19) United States
(12) Patent Application Publication
(10) Pub. No.: US 2010/0157449 A1
(43) Pub. Date: Jun. 24, 2010

(54) Image Capturing Device

(76) Inventor: Tzu-An TSENG, Taipei City (TW)

Correspondence Address: OVERHAUSER & LINDMAN, 740 W. GREEN MEADOWS DRIVE, SUITE 300, GREENFIELD, IN, 46140, US

(21) Appl. No.: 12/338,036

(22) Filed: Dec. 18, 2008

(51) Int. Cl. G02B 7/04

(52) U.S. Cl. 359/823

(57) ABSTRACT

An image capturing device includes a focusing unit. The focusing unit includes an outer barrel that defines a barrel axis and that is mounted with an image capturing unit, an annular flange defining a through-hole, an inner barrel, a focus adjustment barrel, and an optical lens member. The inner barrel is coaxial with and radially spaced apart from the outer barrel. The focus adjustment barrel is rotatably disposed between the outer and inner barrels, and has an inner barrel surface formed with a helical guide slot. The optical lens member is disposed in the inner barrel, is movable along the barrel axis, is optically aligned with the through-hole, and is formed with a guiding projection extending into the guide slot such that rotation of the focus adjustment barrel relative to the inner barrel results in driving of the guiding projection to move the optical lens member along the barrel axis.

### BACKGROUND OF THE INVENTION

1. Field of the Invention

The invention relates to an image capturing device, more particularly to a digital image capturing device.

2. Description of the Related Art

Referring to FIGS. 1 and 2, a lens device 1 found in a conventional image capturing device includes an outer casing 11, an outer tube 12 rotatably disposed in the outer casing 11, an inner tube 13 disposed in the outer tube 12 and movable in a longitudinal direction of the outer tube assembly 12, an optical lens member 14 mounted fixedly in the inner tube 13, a cap 15 disposed at one end of the outer casing 11 and the outer tube 12, and a pair of guiding rods 16 disposed longitudinally in the outer tube 12.

The outer casing 11 has a cutout 111 formed in a top portion thereof, and an annular shoulder 112 formed on an inner surface thereof. The annular shoulder 112 is formed with two downwardly extending recesses 113. The outer tube 12 has an annular knob portion 121 corresponding in location to the cutout 111 and is formed with an internal thread 122 on an inner surface thereof. The inner tube 13 is formed with an outwardly extending annular flange 131 on a top part thereof, a pair of opposite projections 132 protruding from the annular flange 131 and extending into the internal thread 122, and a pair of opposite through-holes 133 formed in the annular flange 131 and registered with the recesses 113 of the outer casing 11, respectively. The cap 15 is formed with a pair of opposite inwardly extending lugs 151 registered with the through-holes 133 in the inner tube 13. The guiding rods 16 respectively extend through the lugs 151, the through-holes 133, and the recesses 113. A circuit board 5 mounted with an image sensor 3 is disposed in the cap 15.

With further reference to FIG. 3, since the projections 132 of the inner tube 13 extend into the internal thread 122, the inner tube 13 is able to move in the outer tube 12, under the guidance of the guiding rods 16 when the outer tube 12 is rotated, which results in adjustment of a distance between the optical lens member 14 and a specimen (not shown).

One problem associated with the conventional lens device 1 is that since the inner tube 13 is movably disposed in the outer tube 12 under the guidance of the guiding rods 16, resistance is often introduced between the inner tube 13 and the guiding rods 16 when rotating the annular knob portion 121. In effect, it causes non-smooth operation and noise attributed to friction.

### SUMMARY OF THE INVENTION

Therefore, the object of the present invention is to provide an image capturing device capable of overcoming the above-mentioned drawbacks of the prior art.

According to the invention, an image capturing device includes a focusing unit and an image capturing unit. The focusing unit includes an outer barrel that defines a barrel axis, an annular flange that extends in radial inward directions from the outer barrel and that defines a through-hole, an inner barrel, a focus adjustment barrel, and an optical lens member. The inner barrel is disposed on one side of the annular flange in the outer barrel, is coaxial with and radially spaced apart from the outer barrel, and is formed with a slit extending parallel to the barrel axis. The focus adjustment barrel is rotatably disposed between the outer and inner barrels and has an inner barrel surface formed with a helical guide slot. The optical lens member is disposed in the inner barrel, is movable along the barrel axis, is optically aligned with the through-hole, and is formed with a guiding projection extending through the slit in the inner barrel and into the guide slot in the focus adjustment barrel such that rotation of the focus adjustment barrel relative to the inner barrel results in driving of the guiding projection to move the optical lens member along the barrel axis. The image capturing unit is mounted to one end of the outer barrel.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a lens device found in a conventional image capturing device;

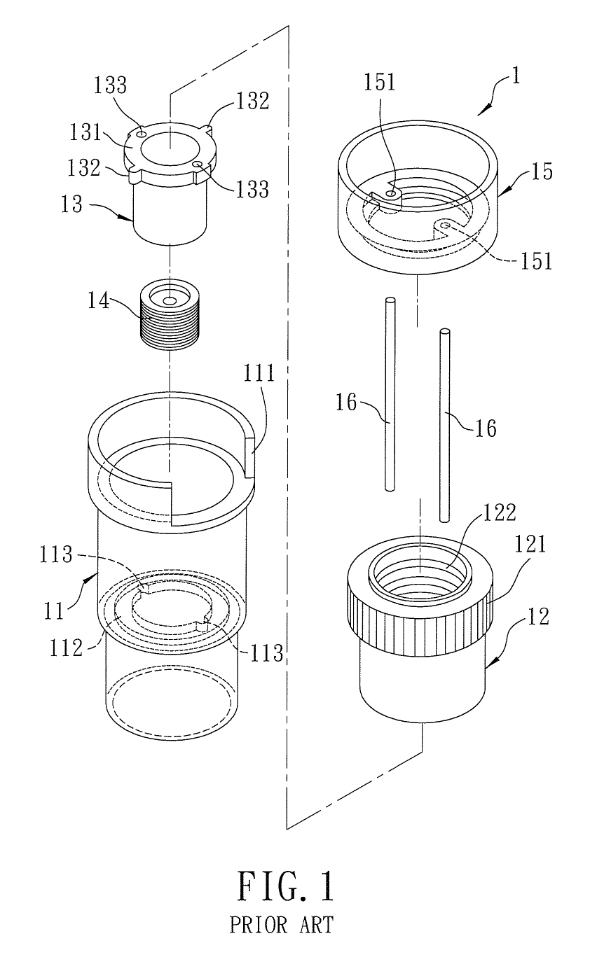

FIG. 2 is a sectional view of the conventional lens device shown in FIG. 1;

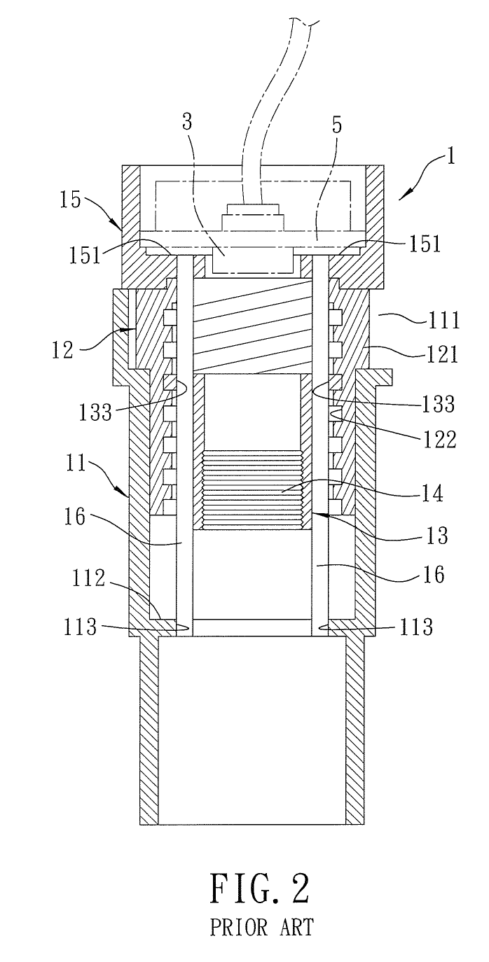

FIG. 3 is another sectional view of the conventional lens device to illustrate an inner tube moved in an outer tube under the guidance of guiding rods;

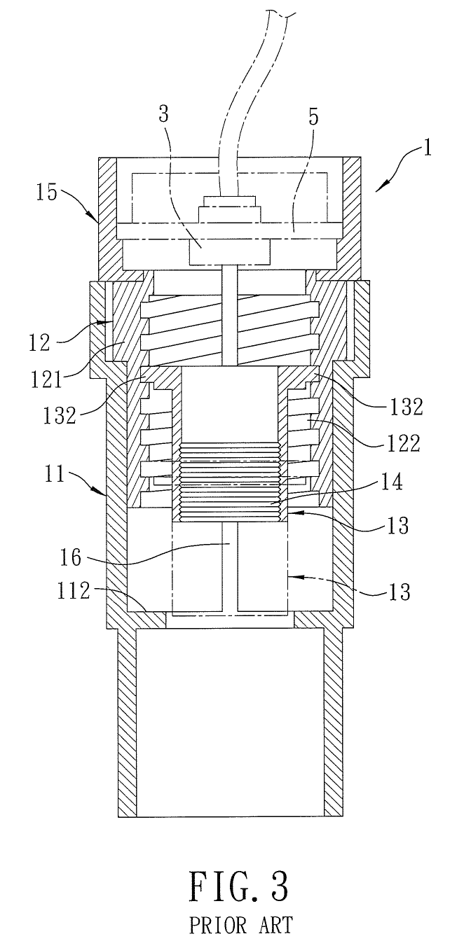

FIG. 4 is an assembled perspective view of the preferred embodiment of an image capturing device according to the present invention;

FIG. 5 is an exploded perspective view of the preferred embodiment shown in FIG. 4;

FIG. 6 is a sectional view of the preferred embodiment to illustrate a guiding projection of an optical lens member engaging a helical guiding slot in a focus adjustment barrel; and

FIG. 7 is a sectional view of the preferred embodiment to illustrate the optical lens member moved in the focus adjustment barrel along a barrel axis.

### DETAILED DESCRIPTION OF THE PREFERRED EMBODIMENT

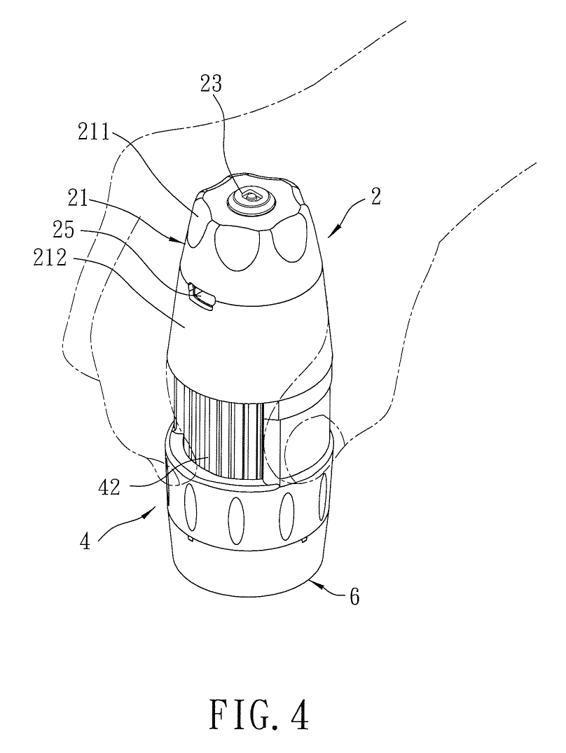

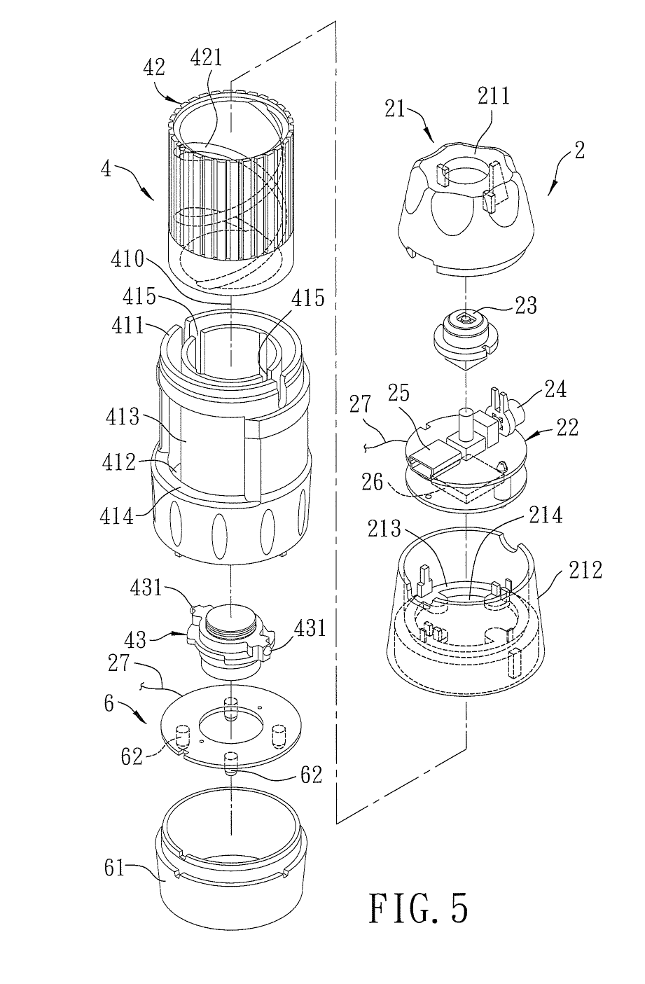

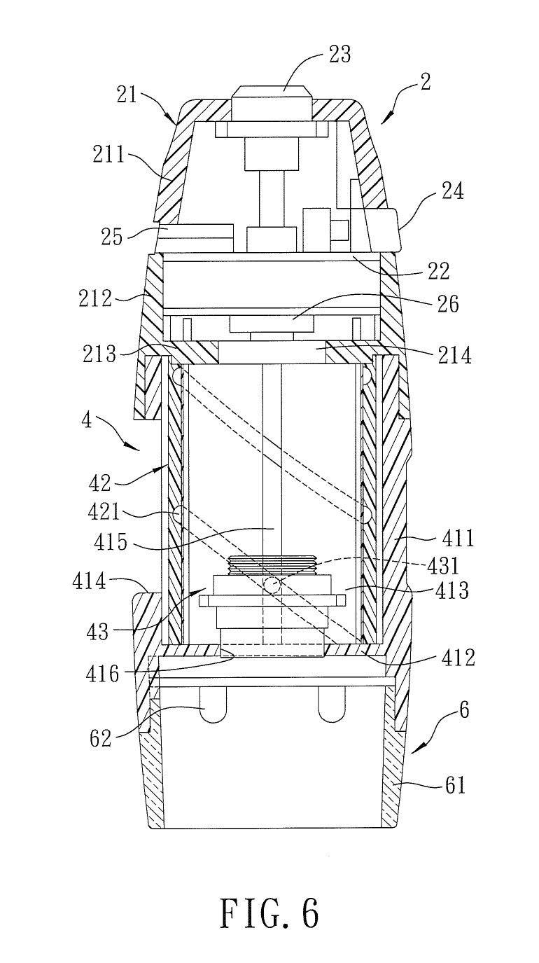

Referring to FIGS. 4 to 7, the preferred embodiment of an image capturing device according to the present invention includes an image capturing unit 2, a focusing unit 4, and a lighting unit 6. The focusing unit 4 includes an outer barrel 411 that defines a barrel axis 410, an annular flange 412 that extends in radial inward directions from the outer barrel 411 and that defines a through-hole 416, an inner barrel 413, a focus adjustment barrel 42, and an optical lens member 43. The inner barrel 413 is disposed on one side of the annular flange 412 in the outer barrel 411, is coaxial with and radially spaced apart from the outer barrel 411, and is formed with a pair of opposite slits 415 extending parallel to the barrel axis 410. The focus adjustment barrel 42 is rotatably disposed between the outer and inner barrels 411, 413, and has an inner barrel surface formed with a helical guide slot 421. The outer barrel 411 is formed with a radial opening 414 to permit access to the focus adjustment barrel 42 for rotating the focus adjustment barrel 42 relative to the inner barrel 411. The optical lens member 43 is disposed in the inner barrel 411, is movable along the barrel axis, is optically aligned with the through-hole 416, and is formed with a pair of opposite guiding projections 431 extending through the slits 415 in the inner barrel 413 and into the guide slot 421 in the focus adjustment barrel 42 such that rotation of the focus adjustment barrel 42 relative to the inner barrel 411 results in driving of the guiding projections 431 to move the optical lens member 43 along the barrel axis.

The image capturing unit 2 includes a casing 21 coupled to one end of the outer barrel 411 through male-female engaging means and having an annular end wall 213 abutting against top edges of the focus adjustment barrel 42 and the inner barrel 413, a control module 22 disposed in the casing 21, a control button 23, a light controller 24, an output port 25, and an image sensor 26 optically aligned with the optical lens member 43. The casing 21 is formed with a top portion 211, a bottom portion 212 connected to the top portion 212, and a hole 214 defined by the end wall 213, which extends in radial inward directions from the bottom portion 212. The image sensor 26 is provided on and is coupled electrically to the control module 22. In this embodiment, the image sensor 26 is one of a CCD (Charge Coupled Device) device and a CMOS (complementary Metal-Oxide Semiconductor) device.

The lighting unit 6 includes a light transmissible cap 61 coupled to another end of the outer barrel 411, and at least one light emitting component 62 disposed in the outer barrel 411 on another side of the annular flange 412 opposite to the inner barrel 413. In this embodiment, there are four angularly spaced apart light emitting components 62 and the light emitting components 62 are Light Emitting Diodes (LEDs). The control module 22 is disposed between the top and bottom portions 211,212 and is coupled electrically to the image sensor 26, the light controller 24, and the output port 25. Conductors 27 further connect the control module 22 to the lighting unit 6. In this embodiment, the output port 25 is a universal serial bus port (USB). The control button 23 extends outwardly of the top portion 211 of the casing 21, is coupled electrically to the control module 22, and is operable to activate the control module 22 for generating a digital picture of an image of a specimen (not shown) captured by the image sensor 26 through the optical lens member 43. The light emitting components 62 are provided for improving the quality of captured images of the specimen. The light controller 24, which is a dial in this embodiment, is disposed between the top and bottom portions 211, 212 of the casing 21, extends outwardly of the casing 21, and is operable to activate the control module 22 for adjusting intensity of the light outputted by the light emitting components 62. The output port 25 is disposed between the top and bottom portions 211, 212 of the casing 21 and permits connection of the control module 22 to an external device (not shown), such as a monitor, to permit viewing of images captured by the image capturing device of this invention.

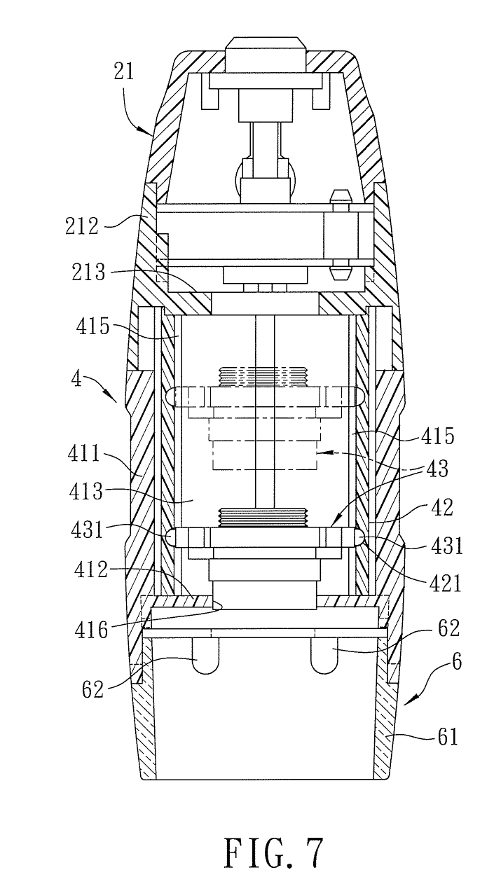

In use, a user can readily rotate the focus adjustment barrel 42 to adjust a focal distance between the optical lens member 43 and the specimen in order to obtain a desirable image magnification of the specimen. The guiding projections 431 move along the helical guide slot 421 to result in driving the optical lens member 43 along the barrel axis (see FIG. 7). In effect, the optical lens member 43 can be conveniently moved to a desirable positino inside the inner barrel 413.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An image capturing device comprising:
a focusing unit including
an outer barrel that defines a barrel axis,
an annular flange that extends in radial inward directions from said outer barrel and that defines a through-hole,
an inner barrel that is disposed on one side of said annular flange in said outer barrel, that is coaxial with and radially spaced apart from said outer barrel, and that is formed with a slit extending parallel to the barrel axis,
a focus adjustment barrel that is rotatably disposed between said outer and inner barrels, and that has an inner barrel surface formed with a helical guide slot, and
an optical lens member that is disposed in said inner barrel, that is movable along the barrel axis, that is optically aligned with said through-hole, and that is formed with a guiding projection extending through said slit in said inner barrel and into said guide slot in said focus adjustment barrel such that rotation of said focus adjustment barrel relative to said inner barrel results in driving of said guiding projection to move said optical lens member along the barrel axis; and
an image capturing unit mounted to one end of said outer barrel.

2. The image capturing device as claimed in claim 1, wherein said outer barrel is formed with a radial opening to permit access to said focus adjustment barrel for rotating said focus adjustment barrel relative to said inner barrel.

3. The image capturing device as claimed in claim 1, further comprising a lighting unit that includes a light transmissible cap coupled to another end of said outer barrel, and at least one light emitting component disposed in said outer barrel on another side of said annular flange opposite to said inner barrel.

4. The image capturing device as claimed in claim 1, wherein said image capturing unit includes:
a casing that is coupled to said one end of said outer barrel; and
an image sensor that is disposed in said casing and that is optically aligned with said optical lens member.

5. The image capturing device as claimed in claim 4, wherein said image capturing unit further includes:
a control module that is disposed in said casing and that is coupled electrically to said image sensor; and
a control button that extends outwardly of said casing, that is coupled electrically to said control module, and that is operable to activate said control module for generating a digital picture of an image of a specimen captured by said image sensor through said optical lens member.

6. The image capturing device as claimed in claim 4, wherein said image capturing unit further includes:
a control module that is disposed in said casing and that is coupled electrically to said image sensor; and
an output port that is disposed on said casing and that is coupled electrically to said control module to permit connection of said control module to an external device.

7. The image capturing device as claimed in claim 6, wherein said output port is a universal serial bus port.

8. The image capturing device as claimed in claim 4, further comprising a lighting unit that includes a light transmissible cap coupled to another end of said outer barrel, and at least one light emitting component disposed in said outer barrel on another side of said annular flange opposite to said inner barrel.

9. The image capturing device as claimed in claim 8, wherein said image capturing unit further includes a control module disposed in said casing and coupled electrically to said lighting unit, and a light controller extending outwardly of said casing, coupled electrically to said control module, and operable to activate said control module for adjusting intensity of light outputted by said light emitting component.
